(19) United States
(12) Patent Application Publication
(10) Pub. No.: US 2007/0124315 A1
(43) Pub. Date: May 31, 2007

(54) Computer equipment for an actor of a logistic chain

(75) Inventors: Baptiste Guivarch, Aeigne (FR); Lionel Guivarch, Rennes (FR); Yves-Marie Roth, Saint Gregoire (FR); Nicolas Gestraud, Rennes (FR); Vincent Texier, Rennes (FR)

Correspondence Address: Darin Bartholomew;Patent Department Deere & Company, 1 John Deere Place, Moline, IL, 61265, US

(73) Assignee: JOHN DEERE AGRI SERVICES, INC., Moline, IL (US)

(21) Appl. No.: 10/549,891

(22) PCT Filed: Mar. 30, 2004
(86) PCT No.: PCT/FR04/50136

§ 371 Date: Sep. 16, 2005

(30) Foreign Application Priority Data
Mar. 31, 2003 (FR) 03/03926

(51) Int. Cl. G06F 7/00

(52) U.S. Cl. 707/100

(57) ABSTRACT

The invention concerns informatics equipment for an actor in a logistic chain of production or processing of products, more specifically of food products. This equipment comprises: the means to create document models based on heading modules and attribute modules, said document models being comprised on the one hand, of at least one heading (R₁, R₂ and R₃) and on the other hand, of at least one attribute (A₁, A₂ and A₃) for each heading, comprising a data base, at least one of the attributes being a link to another document, comprising means for acquiring the documents with interfaces for acquiring the values (V₁, V₂ and V₃)

The invention relates to a process for establishing forms with the aid of informatics equipment for actors in a logistic chain of production or processing of products, more specifically of food products. It also concerns the equipment and system needed to implement such a process.

Food product safety is a major concern for regulatory authorities and consumers. This is why considerable efforts have been expended in recent times to facilitate the traceability of food products in the logistic chain. These efforts have been regulatory as well as technical.

More specifically, the French patent application nr. 00/11439, filed on Sep. 7, 2000, proposes means that allow for facilitating said traceability based on a plurality of data bases that link the different actors in the chain of food products, the professional organizations and the consumers. The system described in this patent application offers the possibility of easy access to the information relating to a specific food product, depending on the rights conferred to each specific actor, organization or consumer.

In the patent application PCT/FR 03/00553, filed on Feb. 19, 2003 in the name of the applicant, is also described a service platform to link, preferably by way of the Internet network, the informatics equipment of actors in a logistic chain of production or of processing of products, more specifically, of food products which comprises:
a data base with traceability intended to receive the informatics equipment of each actor in the logistic chain, the identifier of the operation conducted, the identifier of the operator, information pertaining to the date the operation was conducted and the identifier of the operation conducted immediately upstream and/or downstream of the actor in question,
a data base memorizing the rights of access of each actor to the information stored in the data bases specific to other actors, and
a data base for routing providing the information needed for routing the information amongst the actors, on the one hand, in function of the data provided by the data base with traceability and, on the other hand, in function of the data base with the rights of access.

This architecture is of great simplicity for establishing interaction amongst the various actors in a logistic chain. Furthermore, it allows for ensuring easy traceability while maintaining confidentiality on the information specific to each actor.

This platform can comprise a data base for routing that contains the identification and the location finder of the issuers of specification sheets and of the operators using these specification sheets, the data bases of the issuers of the specification sheets and the data bases of the concerned operators that are being set up for interaction based on the data provided by the data base for routing and by the data base on rights of access.

Also described in this prior PCT patent application is equipment for data acquisition and data consultation intended to be linked to the platform which comprises the means, during acquisition of data, for the automatic transmission, to a data base with traceability, of the identifier of the operation conducted, of the operator's identifier, of information pertaining to the date the operation was conducted, and of the identifier of the operation conducted immediately upstream and/or downstream of the actor owning the acquisition and consultation equipment.

This equipment can comprise the means for receiving specification sheets consisting of the identifications of operations or of products to be used or of the parameters or of the ranges of parameters, and can comprise the means to verify that the operations committed to memory with the aid of said informatics equipment are in compliance with the specification sheets.

In short, the means described in this prior PCT patent application allow for quickly alerting the participants and the consumers in case of an incident concerning a product, that is to say, that said means allow for more easily pinpointing the origin of the incident.

The invention comes as the result of the realization that in order to facilitate the implementation of means allowing for traceability, it is necessary to make available to the actors in the logistic chain means that are easy to use when acquiring documents and, preferably, that allow for easily modifying the documents without the intervention of a service provider such as an editor of software.

The system in accordance with the invention is characterized in that each actor in the logistic chain is equipped with means of informatics allowing him/her to generate document models with operating parameters for headings and attributes, said attributes comprising the basic data, and in that, in each document, at least one attribute is provided which comprises a link to another document model, and means are provided so that an actor, or a user can, based on the knowledge of a document or of a heading or of an attribute, have access to at least certain values of attributes owing to the link between the documents.

Thus, each actor has at his disposal a “standardized” document model which allows for obtaining traceability in a simple and automatic manner.

The document models can easily be modified by adding or removing headings and by adding or removing attributes.

Under these conditions, the actors do not need to call upon a software editor to manage the evolution of their activities.

Preferably, each link created in a document is transmitted to a data base with traceability such as the data base described in the PCT patent application mentioned above, said data base allowing for easy routing of the information.

In one form of embodiment, each document model comprises the means to assign to each attribute the right of access for actors other than the holder of the document. These rights of access are, for example, the right to read and to write, or solely the right to read, or denial of access.

In a document, a specific right of access can correspond to each attribute and/or heading.

Thus, the invention concerns informatics equipment for an actor in a logistic chain of production or processing of products, more specifically of food products, which comprises:
the means to create document models based on heading modules and attribute modules, said document models being comprised on the one hand, of at least one heading and, on the other hand, of at least one attribute for each heading, comprising a data base, at least one of the attributes being a link to another document,
the means for acquiring the documents with interfaces for acquiring the values of the headings and of the attributes, and
the means, upon each acquisition of a document, to transmit the information acquired from the link/s to a traceability data base, said transmission being preferably conducted via a network of the Internet type.

According to a form of embodiment, the equipment comprises the means to assign to each attribute a right of access to third parties.

Said means to assign a right of access to third parties can comprise means, for each third party, to establish a right of access selected from the group that comprises: the right to read, the right to read and write, and denial of access.

In one form of embodiment, means are provided to assign to each attribute a traceability index so that the attribute constitutes a point of entry for a traceability search for another actor.

The equipment can comprise means to assign to each attribute a search criterion characteristic or means not to assign one.

The equipment can comprise means to issue a search request based on at least one traceability index and on at least one search attribute.

For example, the equipment comprises the means to assign to each attribute a parameter format, a list format or a table format.

According to one form of embodiment, the equipment comprises the means to make the attribute be of a type selected from within the group that comprises simple attributes determined by direct acquisition, calculated attributes determined by calculation with the aid of other parameters, attributes extracted from other documents or files, and composite attributes, a composite attribute being a set of ordered attributes.

The equipment can comprise means to receive specification sheets consisting in the identifiers of operations or of products to be used or of parameters or of ranges of parameters, and can comprise means to verify that the operations committed to memory with the aid of said informatics equipment comply with the specification sheets.

The invention also concerns a system to link, preferably by way of the Internet network, multiple informatics equipment, such as the ones defined above, of actors in a logistic chain of production or processing of products, more specifically of food products, comprising a platform which includes the following:
a data base with traceability intended to receive informatics equipment from each actor in the logistic chain, attributes comprising the identifier of an operation to be conducted, the identifier of the operator, information pertaining to the date the operation was conducted and the identifier of an operation to be conducted immediately upstream and/or downstream of the concerned actor,
a data base memorizing the rights of access of each actor to the information stored in the data bases specific to other actors, and
a data base for routing providing the information needed for routing the information between the actors in function of, on the one hand, data provided by the traceability data base and, on the other hand, in function of the data base with the rights of access.

Other characteristics and advantages of the invention will emerge from the description of its specific forms of embodiment, this description being elaborated in reference to the drawings hereby appended in which:

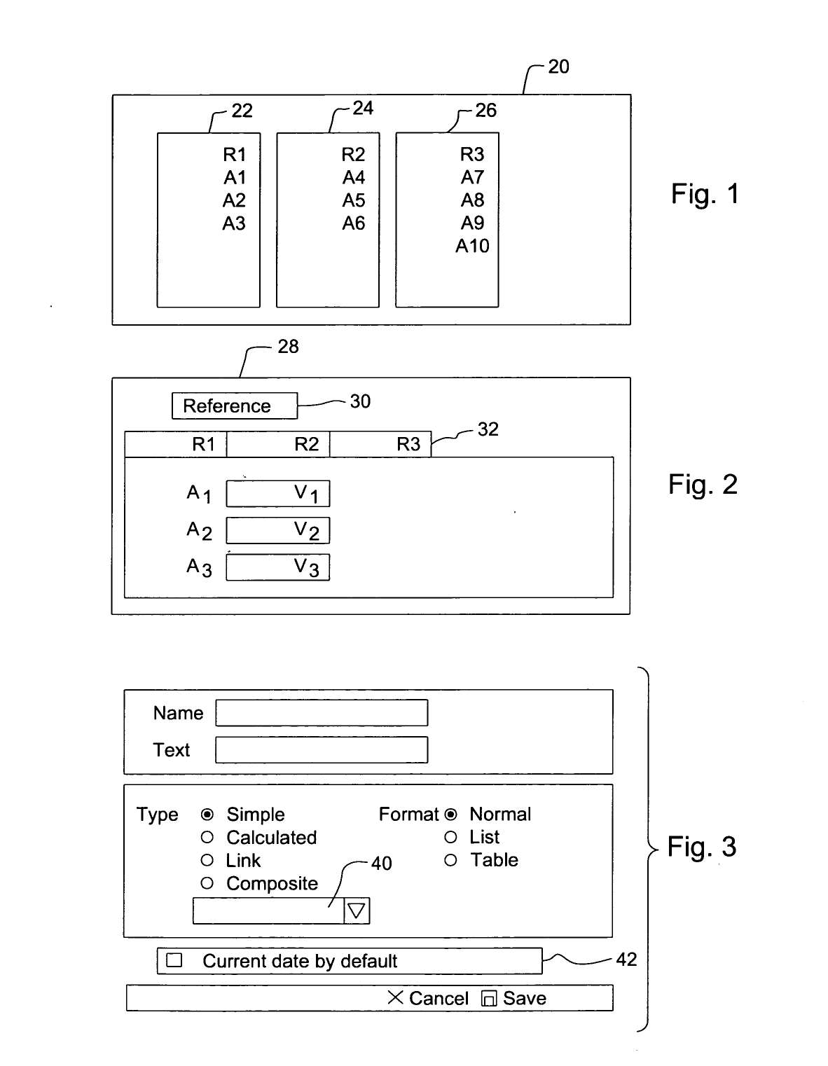

FIG. 1 represents a document model,

FIG. 2 represents a document to be acquired, and

FIGS. 3 through 5 represent means of acquiring attributes.

The form of embodiment of the invention that we shall now describe concerns the management of the logistics chains in the lines of food products. It concerns the various lines of products such as the lines of animal products and the lines of produce products. It can be applied at the various levels of these lines of products, for example, by the agriculturist as well as by the baker to an equal extent. Acquisition by means of informatics equipment is close to the acquisition of documents in the form of paper used to date. The documents can be modified. One can also add documents. It also allows for documents of synthesis [merging] and analysis.

It is equally important to note that the acquisition of information is not centralized since in the domains in which most of the actors participate, we have confirmed a reluctance by the participants to provide information to a centralized data base.

The form of embodiment that we shall describe also allows secure access, and depending on the preestablished profiles, it allows secure access to a portion of the information for users who are external to the enterprise in which the acquisition is conducted.

This form of embodiment, as indicated below, allows for managing the traceability of the data acquired with the aid of the documents created. Finally, it allows for managing and verifying the quality and it can be used in various languages.

In order to realize these various objectives, each actor is equipped with informatics equipment comprising, on the one hand, means for creating or modeling documents and, on the other hand, means for acquiring data from the documents created in this manner.

The various documents of the actors that are to be linked to one another in a logistic chain are accessible by way of an Internet type network that allows access to a significant number of actors at a moderate cost.

In the equipment of each actor, means are provided for generating documents or forms, and each form 20 (FIG. 1) comprises a set of headings 22, 24, 26 and, under each heading is provided a set of attributes which are basic data.

Thus, the user can create multiple headings as desired. Of course, the number of headings is not limited to three as represented in FIG. 1 and, under each heading, one can create an unlimited number of attributes.

As an example here, we shall take an agriculturist owning several parcels. For each parcel, a document is provided presenting the following headings:
characteristics of the parcel,
crops,
seedbeds,
fertilizers,
insecticides,
harvest.

In this example, the attributes under the heading “characteristics of the parcel” are:
type of soil,
surface,
cadastral reference number of farm.

Under the heading “crops”, the attributes are:
type of product (wheat, for example),
product variety.

Under the heading “seedbeds”, one can provide the following attributes:
date seeds sowed,
type of seed,
quantity of seeds sowed,
certified seeds (yes/no).

Under the heading “fertilizers”, the attributes are, for example:
fertilizing date,
type of fertilizer,
quantity of fertilizer.

Under the heading “insecticides”, for example, the attributes will be:
date of treatment,
type of insecticide,
quantity of insecticide,
also provided will be a calculated attribute that will be the density of insecticide per surface unit.

Under the heading “harvest”, the following attributes are provided:
date,
quantity of harvest,
destination of the harvest, for example, the references of a silo storage organization,
mode of transport (trailer, truck or other).

It is important to note that assigned to the destination attribute will be a characteristic link to another document which will be, for example, the delivery sheet to the storage organization.

In other words, a characteristic link is assigned to certain attributes, and said attributes of linkage are used in a data base with traceability to effect routing of the information which allows for traceability, as we shall see further below.

FIG. 2 represents a created document that is ready for use with the reference 30 heading of the document such as, in the example, a number and the name of the parcel and a reference date, such as “countryside 2002”.

The names of the headings appear in a tab 32 and access to the corresponding tab, for example R₁ provides the various attributes. Thus, in FIG. 2, one sees three attributes A₁, A₂ and A₃ with a box for the value of each attribute.

Each informatics equipment unit thus comprises the possibility of conferring specific properties to each attribute when creating a document.

As represented in FIG. 3, each attribute is assigned a name and a descriptive text as well as a characteristic which is, for example, of a type selected from among a group comprised of the following types: simple, calculated, with a link or composite. Also assigned to the attribute is a format selected from within a group comprising the standard format (a parameter), a list format or a table format.

Thus, in the case of the simple type, in the event of free access, the possibility is provided to select from among the following options from within a window 40: yes/no, text with 10 characters, text with 30 characters, text with 50 characters, long text, date, date and time, decimal number, value in the list. For certain attributes, the possibility will also be offered to make a selection from another window 42.

For example and as represented, in the case in which one selects the date, a window 42 will provide the option of having the current date inscribed by default. In the case of a numerical value, the window 42 will ask, for example, for the unit and, in the case where the value is selected from a list, one will be asked to select the list from this window.

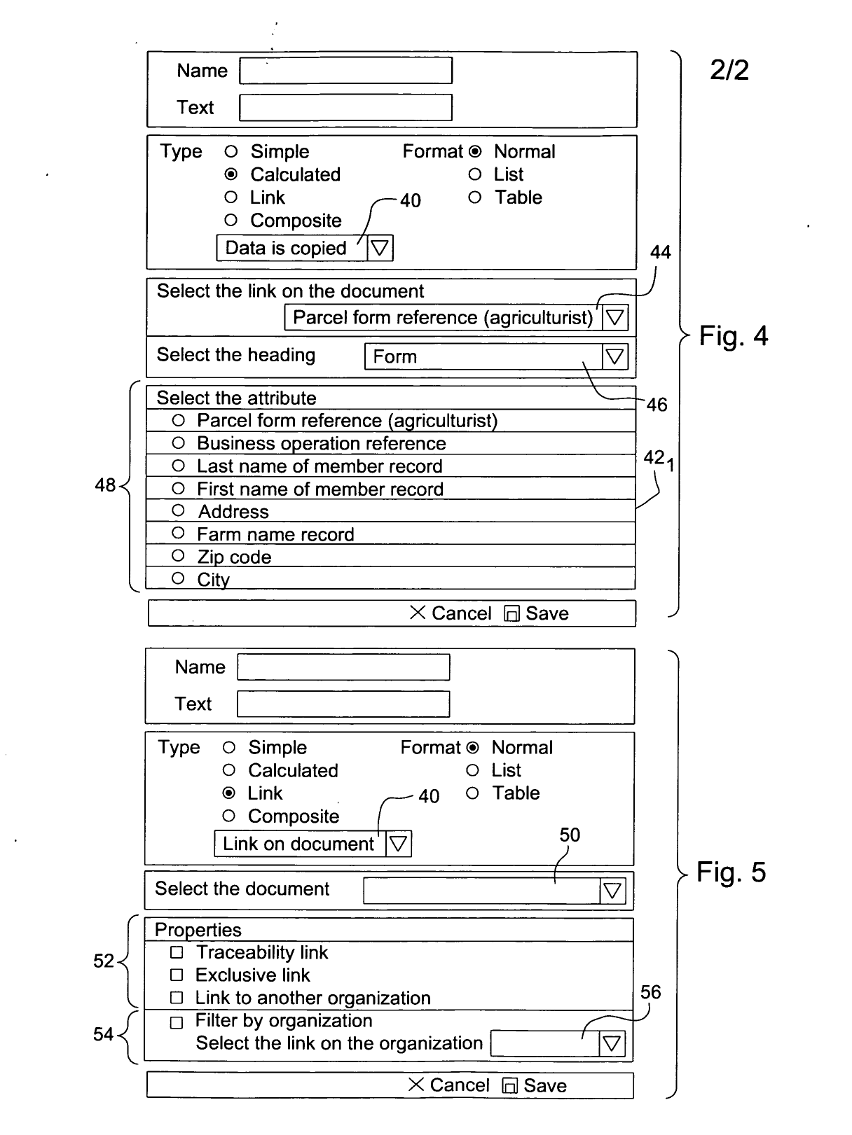

In the case where the attribute is of the calculated type, as shown in FIG. 4, the window 40 indicates the data to be copied in order to make the calculation. These data to be copied are, in general, on other documents and, thus, a zone 42 allows for selecting the concerned document from a window 44 and for selecting the heading in this document from a window 46. Finally, one must (zone 48) select the attribute under the selected heading. The calculation is carried out by a mathematical operation to be selected in the window 40.

The calculated data can also be automatic organization data, that is to say, data originating from documents describing the organization such as the farm for the farmer. Thus, one can easily reference data that are frequently recalled in the various documents created by the farmer. These data are, for example, the address, the name of the farming operation and the code of the farmer's supplier opposite the storage organization, for example. The calculated data can also be an incremental reference, that is to say a reference which automatically increases by increments upon calculation.

For example, the document reference will bear a prefix, such as DS [BL] for the “delivery sheet” and an incremental number so that it can be differentiated from the preceding documents, as well as a suffix which will correspond, for example, to the destination of the delivery sheet such as SO [OS] for the “storage organization”.

FIG. 5 represents the attribute for the link which, if we recall, allows for conducting traceability. Thus, when the “link” type is selected, the window 40 offers the possibility of linking up with a document or with a list or even yet with a file. In this case, a window 50 will allow for selecting the document or the list or the file. Furthermore, in zone 52, it is provided that the properties of the links can be indicated, more specifically, either a traceability link, or an “exclusive” link (that is to say, a link which can be used several times), or a link to another organization.

By link to another organization we mean a link to another set of document models.

In this case, in zone 54, a window 56 is provided for selecting the link to the other document system.

When the traceability link has been established, it can be transmitted to a traceability data base to construct a tree or a routing path for linked documents.

Likewise, when a link is selected from a list, software means allow for selecting the “list” type attribute from among the lists that are available. In this case as well, the link can be a traceability link and/or an exclusive link and/or yet a link to another organization.

In the case of a link on a file, the possibility will be provided for posting the link or for posting the file such as an image embedded in a document. These files will be, for example, of the .doc, .jpg (.gif), .pdf, .xls or .txt type.

The mathematical operations that can be performed are, for example, addition, subtraction, multiplication, division, summing up and mean calculation.

For adding, subtracting, multiplying and dividing, the informatics equipment will propose, by way of its interface, the selection of two variables from among the following options:
a constant,
an attribute in the current document,
an attribute in a linked document.

One must then select the document, the heading and the attribute.

In the case of addition, the equipment allows for selecting and modifying the variables as desired.

In the case of summing up or of mean calculation, which concern operations on various values from a same attribute, one therefore selects only one single attribute based on any desired document. But the attribute must be filtered by the site or by traceability. Filtering by site consists in selecting all of the values of a parameter (for example, the proportion of proteins measured upon arrival) that exist in the documents of the concerned site. Filtering by traceability consists in selecting all of the values of a parameter along the chain (for example, the proportion of proteins measured by the miller upon arrival, measured upon exiting the silos of the storage organization, measured upon delivery to the agriculturists).

If we now go back to the example provided above, the “parcel sheet” document is linked by the “destination” attribute to another document which is a “delivery sheet” to a storage organization. This delivery sheet will also have as a link attribute the origin of the delivery, that is to say, the link with the “parcel sheet” document. Thus, the delivery sheet will comprise the attribute for its reference, the attribute of the parcel of origin, the attribute of the date and an attribute for the mode of transport of the parcel to the storage organization.

The “delivery sheet” document is linked to another document which is a “data input sheet” in a storage organization. The attributes of this document will therefore be the delivery sheet number, the original agriculturist, the parcels, the date, the quantity. In this case, the link attribute is the delivery sheet number. However, the link can also be ascribed to other attributes (or assigned in place of the attribute), for example, to the date, to the parcel or to the agriculturist.

In the storage organization, one can also create a document that comprises a report of analysis with headings or attributes relating to the products received with, each time, the origin such as the agriculturist, the parcel, the date, the quantity, etc.

A report of analysis is comprised, for example, by the quality parameter values measured on the products received. These parameters can be, by way of example, the proportion of protein, Hagberg's crop time, the rate of humidity, etc.

In this example, the document that follows, which is also in the storage organization, is a document relating to the movements inside of the silos.

We know in fact that a silo comprises several compartments and one needs to determine the dates and quantities of products transferred from one compartment to another in order to know what mixtures were made in this silo.

In a more precise way, for each compartment, one provides a heading with the date and the contents of each compartment as attributes. This document allows to determine what is discharged from each compartment so as to be able to more specifically comply with the specification sheets drawn up by a miller.

Thus, the following document is a delivery sheet from the silo to a miller. This delivery sheet therefore comprises the following attributes:
the reference of the delivery sheet,
the reference of the silo of origin, and
the destination.

Owing to the various links created in the documents, it is possible to establish traceability of a product from upstream toward downstream or from downstream toward upstream.

For example, it is possible for the miller to determine which agriculturists provided the wheat that is being used.

In a general manner, one can create document models by professions or by lines of products, such as, for example, a document model for the poultry industry, a document model for the cereal industry and a document model for the pork industry. In addition to the traceability data, these documents allow for providing a quality analysis and reports that relate to the products. For example, the party in charge of supplying flour to an industrial baker will be able to establish statistics on the various supplies he receives with the origin of the products and the grades of quality of the products delivered. This data thus allows for determining a quality scale for supplier goods.

In the described form of embodiment, the documents are managed by the aid of XML technology which is the established computer language of the technological community that facilitates the exchange of data between applications and systems.

1. An informatics system for an actor in a logistic chain of production or processing of food products, the system comprising:
a creation means for creating document models based on heading modules and attribute modules for a document, said document models being comprised of at least one heading and at least one attribute for each heading, comprising an attribute database, at least one of the attributes being a link to another document,
an acquisition means for acquiring the documents with interfaces for acquiring the values of the headings and attributes, and
upon each acquisition of a document, a transmitting means for transmitting the information acquired from the link/s to a traceability data base, said transmitted information being preferably conducted via a communications network.

2. The system according to claim 1 further comprising an assignment means for assigning to each attribute a right of access to third parties.

3. The system according to claim 1 further comprising an assignment means to assign a right of access to third parties, right of access selected from the group that comprises: the right to read, the right to read and write, and denial of access.

4. The system according to claim 1 further comprising assignment means to each attribute a traceability index so that the attribute constitutes a point of entry for a traceability search for another actor.

5. The system according to claim 1 further comprising assignment means to assign to each attribute a search criterion characteristic or means not to assign one.

6. The system according to claim 1 further comprising the means to issue a search request based on at least one traceability index and on at least one search attribute.

7. The system according to one of the claim 1 further comprising an assignment means to assign to each attribute a parameter format, a list format or a table format.

8. The system according to claim 1, further comprising means to make the attribute be of a type selected from within the group that comprises simple attributes determined by direct acquisition, calculated attributes determined by calculation with the aid of other parameters, attributes extracted from other documents or files, and composite attributes, a composite attribute being a set of ordered attributes.

9. The system according to claim 1 further comprising the means to receive specification sheets consisting in the identifiers of operations or of products to be used, or of parameters or of ranges of parameters, and comprising the means to verify that the operations committed to memory with the aid of said informatics system are in compliance with the specification sheets.

10. The system according to claim 1 to link multiple informatics equipment, preferably by way of the Internet network, of actors in a logistic chain of production or processing of products, more specifically of food products, comprising a platform which includes the following:
a traceability database with traceability intended to receive attributes from informatics equipment from each actor in the logistic chain, attributes comprising the identifier of an operation to be conducted, the identifier of the operator, information pertaining to the date the operation was conducted and the identifier of an operation to be conducted immediately upstream and/or downstream of the concerned actor,
an access database memorizing for storing the rights of access of each actor to the information stored in the databases specific to other actors, and
a routing database for routing providing the information needed for routing the information between the actors in function of data provided by the traceability database and in function of the data base with the rights of access.
